(19) United States
(12) Patent Application Publication
(10) Pub. No.: US 2025/0208296 A1
(43) Pub. Date: Jun. 26, 2025

(54) DISTANCE MEASURING APPARATUS, CONTROL METHOD, AND STORAGE MEDIUM

(71) Applicant: CANON KABUSHIKI KAISHA, Tokyo (JP)

(72) Inventor: YOSHIKI SAJI, Kanagawa (JP)

(21) Appl. No.: 18/947,359

(22) Filed: Nov. 14, 2024

(30) Foreign Application Priority Data
Dec. 20, 2023 (JP) 2023-214353

(51) Int. Cl. G01S 17/894; G01S 7/481; G01S 7/4865; G01S 7/51; H04N 23/63; H04N 23/667

(52) U.S. Cl. CPC G01S 17/894; G01S 7/4814; G01S 7/4865; G01S 7/51; H04N 23/63; H04N 23/667

(57) ABSTRACT

A distance measuring apparatus includes an imaging unit configured to image an object, a distance measuring unit configured to measure a distance to the object using a time from when light is irradiated onto the object to when reflected light from the object is received, a display unit configured to display an image obtained by the imaging unit, a recorder configured to record the image, a processor configured to execute control to prohibit the image recorded in the recorder from being displayed on the display unit, and an notification unit configured to notify outside that the control is being executed.

### BACKGROUND

### Technical Field

The present disclosure relates to a distance measuring apparatus having an imaging function, a control method, and a storage medium.

### Description of Related Art

A distance measuring apparatus has conventionally been known that can measure a distance to an object that reflects light based on the time of flight (ToF) of light from when the light is emitted to when the reflected light is detected, and can display and record the distance measurement information by superimposing it on an image (see Japanese Patent Laid-Open No. 2016-048825).

The Rules of Golf set by the Royal and American Golf Association (R&A), the United States Golf Association (USGA), and the Japan Golf Association (JGA) prohibit the viewing of images that aid play during playing a round of golf. In a case where such a distance measuring apparatus is used for playing golf, playing back recorded videos on the display unit is likely to violate the Rules of Golf. Even if the user does not use the playback function, a third party cannot tell whether or not the playback function has been used, and thus fair play may be impaired.

### SUMMARY

A distance measuring apparatus according to one aspect of the disclosure includes an imaging unit configured to image an object, a distance measuring unit configured to measure a distance to the object using a time from when light is irradiated onto the object to when reflected light from the object is received, a display unit configured to display an image obtained by the imaging unit, a recorder configured to record the image, a processor configured to execute control to prohibit the image recorded in the recorder from being displayed on the display unit, and an notification unit configured to notify outside that the control is being executed. A control method corresponding to the above distance measuring apparatus also constitutes another aspect of the disclosure. A storage medium storing a program that causes a computer to execute the above control method also constitutes another aspect of the disclosure.

Further features of various embodiments of the disclosure will become apparent from the following description of embodiments with reference to the attached drawings.

### BRIEF DESCRIPTION OF THE DRAWINGS

FIGS. 1A and 1B are external views of a distance measuring apparatus according to a first embodiment.

FIG. 2 is a block diagram of the distance measuring apparatus according to the first embodiment.

FIG. 3 illustrates an example image displayed by the distance measuring apparatus according to the first embodiment.

FIG. 4 is a transition diagram of a menu screen regarding recorded data in the distance measuring apparatus according to the first embodiment.

FIG. 5 is a transition diagram of a menu screen regarding a restriction mode setting in the distance measuring apparatus according to the first embodiment.

FIG. 6 is a flowchart illustrating an operation in a restriction mode of the distance measuring apparatus according to the first embodiment.

FIG. 7 is a side view of the distance measuring apparatus according to the first embodiment.

FIG. 8 is a schematic diagram of an elevation difference correcting function of the distance measuring apparatus according to the first embodiment.

FIG. 9 is a block diagram of a distance measuring apparatus according to a second embodiment.

FIG. 10 is a transition diagram of a menu screen regarding a restriction mode setting in the distance measuring apparatus according to the second embodiment.

FIG. 11 is a flowchart illustrating an operation in a restriction mode of the distance measuring apparatus according to the second embodiment.

FIG. 12 is an external view of the distance measuring apparatus according to the second embodiment.

### DETAILED DESCRIPTION

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure. Corresponding elements in respective figures will be designated by the same reference numerals, and a duplicate description thereof will be omitted.

One aspect of this embodiment can be implemented in any electronic apparatus that can have a distance measuring function that measures a distance to an object based on the ToF of light, and an imaging function. Such electronic apparatuses include digital cameras, computer devices (personal computers, tablet computers, media players, PDAs, etc.), mobile phones, smartphones, game consoles, robots, drones, and drive recorders. These are illustrative, and the present disclosure can be implemented in other electronic apparatuses. In the following embodiments, the present disclosure is implemented in a distance measuring apparatus having an imaging function, but an imaging apparatus and an electronic apparatus having a distance measuring function may cooperate to implement the present disclosure.

### First Embodiment

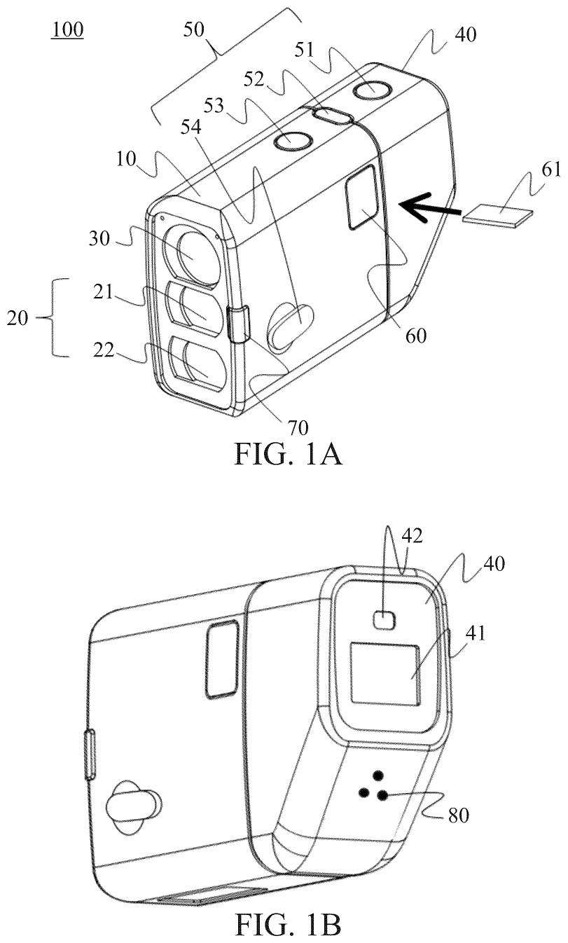

FIGS. 1A and 1B are external views of a distance measuring apparatus 100 according to this embodiment. FIG. 1A is a perspective view of the distance measuring apparatus 100 viewed from the front, and FIG. 1B is a perspective view of the distance measuring apparatus 100 viewed from the back.

The distance measuring apparatus 100 includes a main body 10 and an eyepiece unit 40. The main body 10 includes a distance measuring unit 20, an imaging unit 30, and a recording medium interface (I/F) 60. An outer surface of the distance measuring apparatus 100 is provided with an operation unit 50 including a plurality of input devices, and an identification unit (notification unit) 70 that indicates an operating state of the distance measuring apparatus 100.

The distance measuring unit 20 measures a distance between the distance measuring apparatus 100 and an object that reflects a light beam based on a time difference from when a light emitter 21 emits the laser beam to when a light receiver 22 detects the reflected light, that is, the ToF of the light.

The imaging unit 30 generates image data representing an object image included in an imaging range of a predetermined angle of view. The light emitter 21 is adjusted to emit the laser beam in a predetermined direction within the imaging range of the imaging unit 30.

The eyepiece unit 40 includes a display unit 41 such as a transmission type liquid crystal panel. The display unit 41 can function as an electronic viewfinder (EVF) by displaying a live-view image based on image data sequentially acquired from the imaging unit 30. The eyepiece unit 40 further includes an eye sensor unit 42 that can detect whether a person or the like is approaching it by emitting and receiving infrared light. Thereby, the display unit 41 displays an image only when the user's eye approaches the display unit 41 to peep through the display unit, so that the power consumption of the distance measuring apparatus 100 can be suppressed.

The user can instruct the execution of distance measurement and imaging by operating a run button 51 while viewing an image displayed on the display unit 41. An image illustrating a distance measurement result and information on the distance measuring apparatus 100 can be superimposed on a live-view image.

The operation unit 50 has input devices (switches, buttons, touch panels, dials, joysticks, etc.) operable by the user. The input devices have names corresponding to assigned functions. Although the run button 51, a power button 52, a menu button 53, and a mode switching unit 54 are illustrated in FIGS. 1A and 1B, these are illustrative, and the number and type of input devices and the functions assigned to each input device are not limited to them.

The recording medium I/F 60 stores a removable recording medium (recorder) 61 such as a memory card. The recording medium 61 stored in the recording medium I/F 60 can communicate with the distance measuring apparatus 100 through the recording medium I/F 60. The recording medium 61 is used as a recording destination for image data captured by the imaging unit 30. The image data recorded on the recording medium 61 can be read out and displayed on the display unit 41. The distance measuring apparatus 100 may include a recording medium (recorder) built in the distance measuring apparatus 100 instead of the removable recording medium 61 or separately from the removable recording medium 61. In a case where the distance measuring apparatus 100 cannot use the recording medium 61, the recording medium I/F 60 may be omitted.

The identification unit 70 includes an LED inside, for example, and switches a display state by turning on and off the LED. This configuration notifies the outside of a turning-on or turning-off state of a restriction mode described later, so as to make the state identifiable (recognizable). In this embodiment, the identification unit 70 is configured to indicate the operation state of the distance measuring apparatus 100 by turning on the LED, but another means or method may be used as long as it can indicate the operation state of the distance measuring apparatus 100.

A speaker unit 80 plays an operation sound of the operation unit 50 and audio data recorded on the recording medium 61. The sound data includes audio files and sound portions of moving image files.

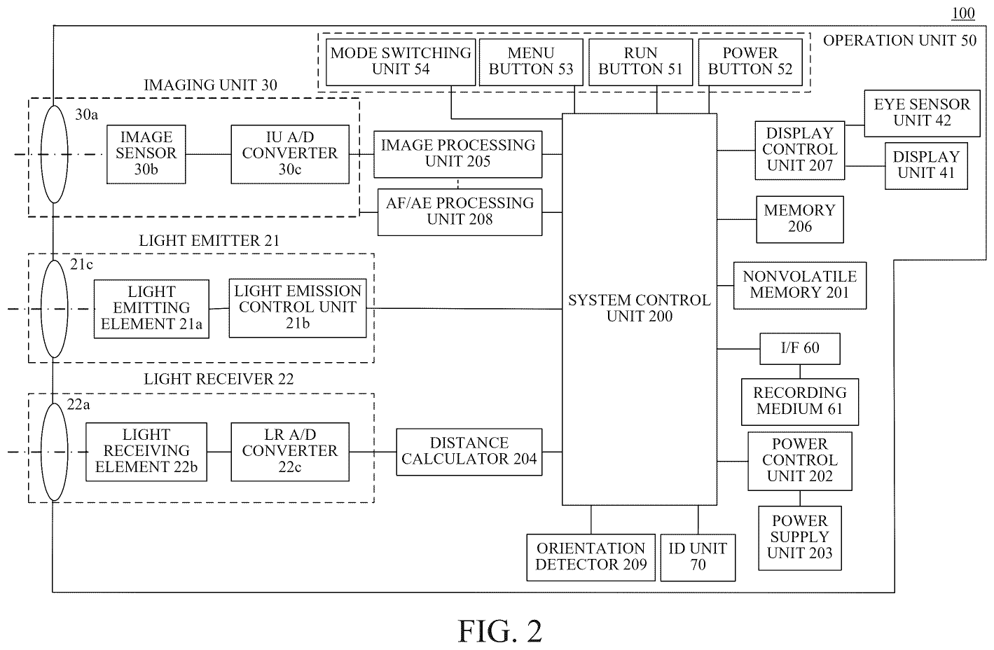

FIG. 2 is a block diagram of the distance measuring apparatus 100. A system control unit 200 includes, for example, one or more processors (CPU, MPU, microprocessor, etc.) capable of executing programs. The system control unit 200 loads the programs stored in a nonvolatile memory 201 into a memory 206 and executes them to control the operation of each unit in the distance measuring apparatus 100 and realize the functions of the distance measuring apparatus 100.

The nonvolatile memory 201 stores the programs to be executed by the system control unit 200, various set values of the distance measuring apparatus 100, and graphic user interface (GUI) data such as images to be superimposed on the menu screen and live-view image.

The memory 206 is used to load the programs to be executed by the system control unit 200 and to temporarily store a distance measurement result, image data, etc. A part of the memory 206 is used as a video memory for storing image data for display. By storing a combined image of a live-view image and an image illustrating additional information such as the distance measurement result in the video memory, an image representing additional information can be superimposed on the live-view image on the display unit 41.

A power control unit 202 detects the type of power supply (battery and/or external power supply) attached to a power supply unit 203, and the type and remaining battery level of the attached battery. The power control unit 202 also supplies the power required by each block including the recording medium 61 based on the detection result regarding the power supply unit 203 and the control of the system control unit 200.

The light emitter 21, the light receiver 22, and a distance calculator 204 constitute the distance measuring unit 20 that measures the distance to a predetermined position within the imaging range of the imaging unit 30. The light emitter 21 includes a light emitting element 21a, a light emission control unit 21b, and an irradiation lens 21c. The light emitting element 21a includes, for example, a semiconductor laser element (laser diode) or the like, and outputs invisible near-infrared light in this embodiment. The light emission control unit 21b controls the operation of the light emitting element 21a to output a pulsed laser beam based on a control signal from the system control unit 200. The laser beam output from the light emitting element 21a is condensed by the irradiation lens 21c and then output from the distance measuring apparatus 100.

The light receiver 22 includes a light receiving lens 22a, a light receiving element 22b, and a light receiver (LR) A/D converter 22c, and detects the reflected light of the laser beam output from the light emitter 21. The light receiving lens 22a condenses the incident light on the light receiving surface of the light receiving element 22b. The light receiving element 22b includes, for example, a photodiode, and outputs a light receiving signal (analog signal) having a magnitude according to the amount of incident light by photoelectric conversion. The light receiving signal output by the light receiving element 22b is converted into a digital signal by the LR A/D converter 22c. The LR A/D converter 22c outputs the digital signal to the distance calculator 204. In a case where the light receiving element 22b is an avalanche photodiode (APD), a numerical value (digital value) according to a received light amount can be obtained by counting the number of pulses output by the APD, and therefore the LR A/D converter 22c is not necessary.

The distance calculator 204 calculates a distance to an object that has reflected the laser beam based on the ToF from when the light emitting element 21a outputs the laser beam to when the light receiving element 22b detects the reflected light. The distance calculator 204 outputs as a distance measurement result to the system control unit 200 the calculated distance in a case where the calculation is successful, or outputs information indicating measurement failure in a case where the calculation is unsuccessful. The distance calculator 204 may output a distance that is not normally obtained, such as a distance of 0, as information indicating the measurement failure.

The imaging unit 30 includes an imaging optical system 30a, an image sensor 30b, and an imaging unit (IU) A/D converter 30c. The imaging optical system 30a includes a plurality of lenses. The plurality of lenses includes a focus lens for adjusting a focal length of the imaging optical system 30a. The lenses include a zoom lens in a case where a focal length of the imaging optical system 30a is variable, and a shift lens in a case where the imaging optical system 30a has a lens shift type image stabilizing function.

The image sensor 30b may include, for example, a CCD or CMOS color image sensor having a primary color Bayer array color filter. The image sensor 30b includes a pixel array on which a plurality of pixels are two-dimensionally arranged, and a peripheral circuit for reading out a signal from each pixel. Each pixel accumulates electric charges according to an incident light amount by photoelectric conversion. By reading out signals having voltages according to an electric charge amount accumulated during the exposure period from each pixel, a pixel signal group (analog image signal) representing an object image formed on the imaging surface by the imaging optical system 30a is obtained. The operation of the imaging unit 30, such as imaging and adjusting a focal length, is controlled by the system control unit 200.

The IU A/D converter 30c A/D-converts the analog image signal output from the image sensor 30b into a digital image signal (image data). The image data output by the IU A/D converter 30c is output to the image processing unit 205.

The image processing unit 205 performs predetermined image processing for the image data output by the IU A/D converter 30c, generates signals and image data according to the application, and acquires and/or generates various information. The image processing unit 205 may include, for example, a dedicated hardware circuit such as an Application Specific Integrated Circuit (ASIC) designed to realize a specific function. The image processing unit 205 may also be configured to realize a specific function by a processor such as a Digital Signal Processor (DSP) or a Graphics Processing Unit (GPU) executing software. The image processing unit 205 outputs the acquired or generated information and data to the system control unit 200.

The image processing applied to the image data by the image processing unit 205 includes, for example, preprocessing, color interpolation processing, correction processing, detection processing, data processing, evaluation value calculation processing, and special effect processing.

The preprocessing includes signal amplification, reference level adjustment, and defective pixel correction.

The color interpolation processing is performed in a case where a color filter is provided on the image sensor 30b, and is processing for interpolating the values of color components that are not included in the individual pixel data that constitutes the image data. The color interpolation processing is also called demosaic processing.

The correction processing includes white balance adjustment, gradation correction, correction of image degradation caused by optical aberrations of the imaging optical system 30a (image recovery), correction of the influence of peripheral dimming of the imaging optical system 30a, and color correction.

The detection processing includes detections of a feature area (e.g., a face area and a human body area) and their movements, person recognition processing, etc.

The data processing includes area cutting (trimming), combination, scaling, encoding, decoding, and header information generation (data file generation), etc. The generation of image data for display and image data for recording is also included in the data processing.

The evaluation value calculation processing includes processing such as generation of signals and evaluation values for autofocus (AF) control and generation of evaluation values for auto-exposure (AE) control. In a case where a signal or evaluation value for AF is generated, the focus lens is driven based on the signal or evaluation value via the AF/AE processing unit 208 for AF processing. In a case where an evaluation value for AE is generated, the sensitivity is adjusted based on the evaluation value via the AF/AE processing unit 208 for AE processing. AE processing may also be performed by changing the aperture value (F-number) or shutter speed.

The special effect processing includes adding an image degradation (blur) effect, changing color tone, and relighting.

The above processing is an example of processing that the image processing unit 205 can apply to image data, and it is unnecessary for the image processing unit 205 to perform all of them, and the image processing unit 205 may perform other processing.

The system control unit 200 stores image data output by the image processing unit 205 in the memory 206. The system control unit 200 stores image data for display in the video memory area of the memory 206. The system control unit 200 generates image data representing information to be superimposed on a live-view image, such as the distance measurement result obtained from the distance calculator 204, and stores the image data in the video memory area of the memory 206.

The display control unit 207 generates a display signal in a proper format based on the image data stored in the video memory area of the memory 206, and outputs the signal to the display unit 41.

The orientation detector 209 includes, for example, a gyro sensor, and detects the orientation of the distance measuring apparatus 100. The orientation information obtained by the orientation detector 209 is sent to the system control unit 200 and used for the elevation difference correction calculation described later. The orientation information obtained by the orientation detector 209 may also be used as image stabilization information for image stabilization in the imaging unit 30.

The operation of the input device provided in the operation unit 50 is monitored by the system control unit 200. The system control unit 200 executes a predetermined operation according to the type and timing of the operated input device.

In a case where the operation of the run button 51 is detected, the system control unit 200 executes the recording of the image captured by the imaging unit 30, the distance measurement by the distance measuring unit 20, etc.

In a case where the operation of the power button 52 is detected, the system control unit 200 switches between the power-on and power-off of the distance measuring apparatus 100.

In a case where the operation of the menu button 53 is detected, the system control unit 200 displays the GUI of the menu screen stored in the nonvolatile memory 201 on the display unit 41.

In a case where the operation of the mode switching unit 54 is detected, the system control unit 200 switches the operation mode of the distance measuring apparatus 100 according to the lever position of the mode switching unit 54. In this embodiment, the distance measuring apparatus 100 has the following operation modes: a imaging mode, a distance measurement mode, and a simultaneous recording mode.

In a case where an operation of another input device provided in the operation unit 50, such as a playback button or arrow keys (directional keys), is detected, the system control unit 200 executes a predetermined operation according to the type and timing of the operated input device. For example, in a case where an operation of the arrow keys is detected while a menu screen is displayed, the system control unit 200 changes the item selected in the menu screen according to the operated arrow keys. In a case where an operation of the run button 51 is detected while a menu screen is displayed, the system control unit 200 changes the setting according to the selected item or transitions to another menu screen.

The imaging mode is a mode in which the operation of the run button 51 is regarded as an instruction to start or end recording. In a case where the distance measuring apparatus 100 is powered on, the system control unit 200 executes an operation in a standby state. The operation in the standby state is an operation for making the display unit 41 function as an EVF. More specifically, the system control unit 200 causes the image processing unit 205 to generate image data for display based on image data sequentially acquired from the imaging unit 30. In addition, the system control unit 200 causes the display control unit 207 to display information on the display unit 41.

In the imaging mode, the system control unit 200 waits for the operation of the run button 51 while continuing the live-view display on the display unit 41. In a case where the operation of the run button 51 is detected, the system control unit 200 records, for example, one frame of the image data for display as a still image in the recording medium 61. The system control unit 200 may record the live-view image in the recording medium 61. Whether to record a still or moving image can be changed by a previous setting. In the case of setting to record a still image, the system control unit 200 records a still image every time the operation of the run button 51 is detected. On the other hand, in the case of setting to record a moving image, the system control unit 200 repeatedly starts and ends the recording of a moving image every time the operation of the run button 51 is detected. In the imaging mode, a distance is not measured.

In the distance measurement mode, the system control unit 200 waits for the operation of the run button 51 while continuing the live-view display on the display unit 41. That the system control unit 200 superimposes an image such as a cursor or pointer indicating a distance measurement point at a predetermined position on the live-view image in the distance measurement mode.

In a case where operation of the run button 51 is detected, the system control unit 200 executes a distance measurement operation. The system control unit 200 controls the light emission control unit 21b to output a pulsed laser beam from the light emitting element 21a, and activates the light receiver 22 and the distance calculator 204. Thereafter, in a case where the system control unit 200 receives the distance measurement result from the distance calculator 204, it displays the distance measurement result (distance or measurement failure) superimposed on the live-view image being displayed. After a predetermined time has passed, or in a case where operation of the run button 51 is detected, the system control unit 200 resumes the live-view display and waits for an operation of the run button 51. In a case where operation of the run button 51 is detected, the system control unit 200 may stop updating the live-view image until a predetermined time has passed, and superimpose the distance measurement result on the frame image at the time of operation of the run button 51.

In the simultaneous recording mode, the system control unit 200 waits for an operation of the run button 51 while continuing the live-view display on the display unit 41. In the simultaneous recording mode, the system control unit 200 displays an image such as a cursor or pointer indicating a distance measurement point at a predetermined position on the live-view image as in the distance measurement mode.

In a case where the operation of the run button 51 is detected, the system control unit 200 executes a distance measurement operation as in the distance measurement mode. The system control unit 200 executes a recording operation of a still or moving image.

For example, in a case where the system control unit 200 detects the operation of the run button 51, it causes the image processing unit 205 to start generating moving image data for recording. In a case where the system control unit 200 detects the operation of the run button 51, it may cause the image sensor 30b to perform still image capturing and cause the image processing unit 205 to generate still image data for recording. The system control unit 200 stores the moving or still image data for recording generated by the image processing unit 205 in the memory 206.

In a case where the system control unit 200 receives the distance measurement result from the distance calculator 204, it stores the distance measurement data (distance or measurement failure) in the memory 206 and displays it in a superimposed manner on a live-view image.

The image data and distance measurement data written in the memory 206 are converted into files in the file portion of the system control unit 200 and recorded in the recording medium 61 via the recording medium I/F 60.

This embodiment newly generates moving and still image data for recording, but may record a moving image for live-view display or record one frame of a moving image for live-view display as a still image.

The moving and still image data have information recorded in a typical digital camera, such as the imaging date and time and information about the settings during imaging, and recorded, for example, in the file header. The distance measurement result may also be similarly recorded in the file header, or may be recorded as a separate file. In the case of recording as a separate file, a common character string is included, for example, in a file name so that it can be understood that the image data file and distance information file are associated.

The system control unit 200 switches the operation mode according to the lever position of the mode switching unit 54. The lever position that the mode switching unit 54 can set may be three positions according to the number of operation modes, or may be two positions such as a mode for irradiating a laser beam and a mode for stopping irradiating a laser beam. In the latter case, for example, the distance measurement mode and the simultaneous recording mode are set to one lever position, and the remaining lever position corresponds to the imaging mode. The distance measurement mode and the simultaneous recording mode may be switched by operating the menu button 53 and the arrow keys. Also, characters or icons indicating the current operation mode may be superimposed on a live-view image.

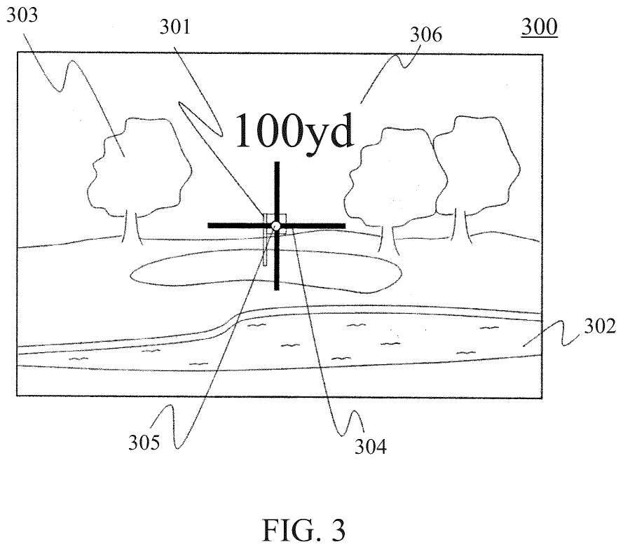

FIG. 3 illustrates an example image displayed after distance measurement in the distance measurement mode or the simultaneous recording mode. This embodiment assumes that the distance measuring apparatus 100 is used on a golf course. A flag 301, a pond 302, and a tree 303 are illustrated in a captured image 300 acquired by the imaging unit 30. Here, the distance to the flag 301 is measured.

As described above, in the operation mode that performs distance measurement according to the operation of the run button 51, an indicator indicating a distance measurement position is superimposed on a live-view image. In FIG. 3, a cross-shaped cursor 304 is illustrated as an example indicator indicating the distance measurement position, but other types of indicators such as a dot-shaped image or an arrow-shaped image may also be used.

The cursor 304 is superimposed so that an intersection 305 is located at a predetermined position on the captured image 300, in FIG. 3, at the center of the captured image 300. The distance measuring unit 20 is adjusted so that it outputs a laser beam toward a position that corresponds to the intersection 305 of the cursor 304 within the imaging range of the imaging unit 30. Therefore, the user can measure a distance to a desired position by adjusting the orientation of the distance measuring apparatus 100 so that the intersection 305 of the cursor 304 is aligned with a position where a distance is to be measured and by operating the run button 51.

In a case where the distance measurement is normally performed, an image 306 indicating the distance is superimposed on the live-view image as the measurement result. In a case where the distance measurement fails, an image of a message or text indicating the measurement failure, such as “error,” “x,” or “measurement failed,” is displayed instead of the distance.

Since FIG. 3 assumes use on a golf course, the distance is illustrated in yards, but the user can make a setting such that the distance may be illustrated in other units such as meters.

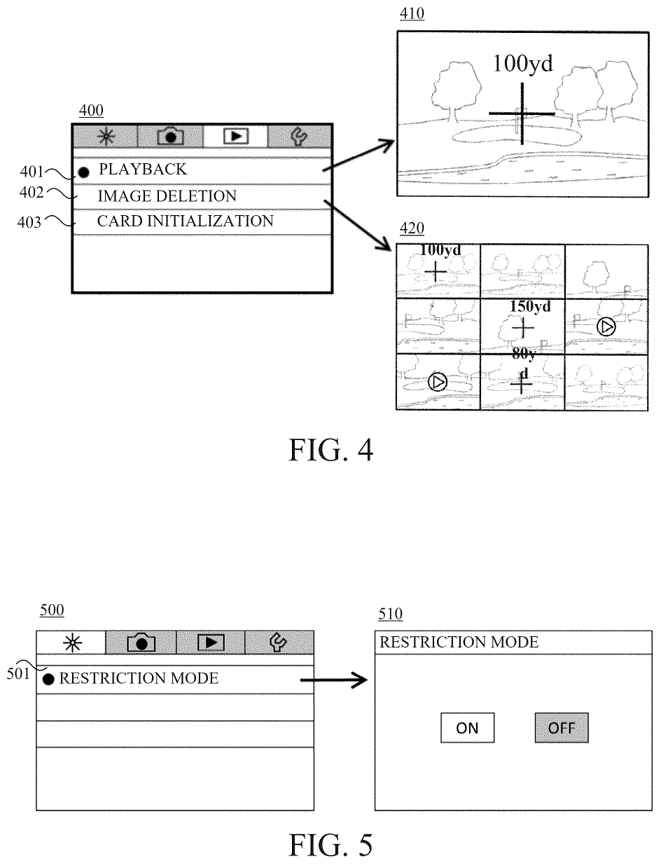

FIG. 4 is a transition diagram of GUI displayed on the display unit 41 in accessing data recorded on the recording medium 61. By operating the menu button 53 and the arrow keys, a playback tab screen 400 is displayed. In a case where a playback menu 401 is executed on the playback tab screen 400, the screen transitions to a playback screen 410 illustrating an image recorded on the recording medium 61. In a case where an image deletion menu 402 is executed, the screen transitions to an image deletion screen 420 where the desired image can be deleted by selecting a thumbnail image. In a case where a card initialization menu 403 is executed, all data recorded on the recording medium 61 is deleted, and the recording medium 61 is returned to its initial state. In a case where the image deletion menu 402 is executed, an option to delete all images at once may be displayed, or the images being displayed may be deleted by operating various input devices of the operation unit 50 while the playback screen 410 is being displayed. The playback screen 410 may be displayed by operating a playback button included in the operation unit 50. The data managed above is not limited to data captured and recorded by the distance measuring apparatus 100, and may be data recorded on the recording medium 61 by another device or program.

FIG. 5 is a transition diagram of GUI displayed on the display unit 41 in switching the restriction mode of the distance measuring apparatus 100 between turning-on and turning-off. In this embodiment, the restriction mode is a mode in which images recorded on the recording medium 61 cannot be displayed on the display unit 41. A setting tab screen 500 is displayed by operating the menu button 53 and the arrow keys. In a case where a restriction mode menu 501 is executed on the setting tab screen 500, a restriction mode switching screen 510 in which the restriction mode can be set to turn on or off is displayed, and the desired state can be selected with the arrow keys, and the selected mode can be set with the decision key. The restriction mode switching screen 510 may display guidance regarding the restriction mode. A function for switching between the turning-on and turning-off of the restriction mode may be assigned to any of the input devices included in the operation unit 50.

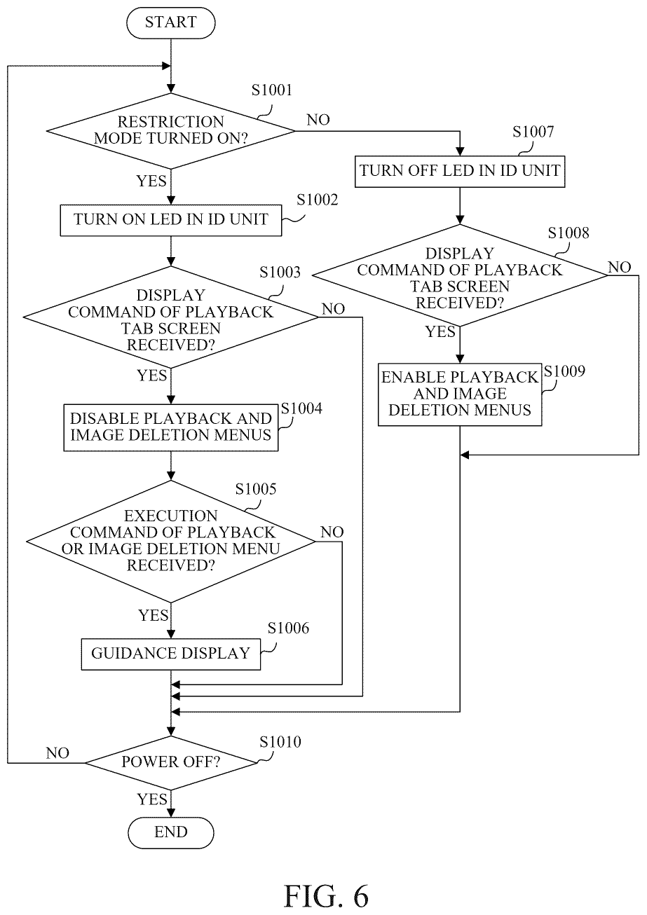

FIG. 6 is a flowchart illustrating the operation of the distance measuring apparatus 100 in the restriction mode. Each processing in the flowchart is achieved by the system control unit 200 executing a program stored in the nonvolatile memory 201 and controlling the operation of each unit. The processing in the flowchart in FIG. 6 is executed from when the power supply of the distance measuring apparatus 100 is turned on.

In step S1001, the system control unit 200 determines whether the distance measuring apparatus 100 is set to the restriction mode. In a case where the system control unit 200 determines that the distance measuring apparatus 100 is set to the restriction mode, it executes the processing of step S1002, and in a case where it determines that the distance measuring apparatus 100 is not set to the restriction mode, it executes the processing of step S1007.

In step S1002, the system control unit 200 causes the LED of the identification unit 70 to emit light, causing the identification unit 70 to be in a lit state. The LED may be constantly emitting light or may be flashing light.

In step S1003, the system control unit 200 determines whether or not a display command for the playback tab screen 400 has been received by operating the menu button 53. In a case where the system control unit 200 determines that it has received a display command, it executes the processing of step S1004, and in a case where it determines that it has not received a display command, it executes the processing of step S1010.

In step S1004, the system control unit 200 disables the playback menu 401 and the image deletion menu 402, and displays them on the playback tab screen 400 in a grayed-out state.

In step S1005, the system control unit 200 determines whether or not it has received an execution command for the playback menu 401 or the image deletion menu 402 based on the user's operation of the operation unit 50. In a case where the system control unit 200 determines that it has received an execution command, it executes the processing of step S1006, and in a case where it determines that it has not received an execution command, it executes the processing of step S1010.

In step S1006, the system control unit 200 displays guidance such as the fact that a recorded video cannot be displayed on the display unit 41 while the restriction mode is set, and does not transition to the playback screen 410 or the image deletion screen 420. The system control unit 200 displays similar guidance even in a case where the playback button included in the operation unit 50 is operated, and does not transition to the playback screen 410.

In step S1007, the system control unit 200 turns off the LED of the identification unit 70.

In step S1008, the system control unit 200 determines whether or not it has received a display command for the playback tab screen 400 by operating the menu button 53. In a case where the system control unit 200 determines that it has received a display command, it executes the processing of step S1009, and in a case where it determines that it has not received a display command, it executes the processing of step S1010.

In step S1009, the system control unit 200 displays the screen illustrated in FIG. 4 on the display unit 41, and waits in the reception state of the playback menu 401, image deletion menu 402, and card initialization menu 403. In a case where any of the above menus is selected and executed, a transition to the playback screen 410, a transition to the image deletion screen 420, and a card initialization function are executed.

In step S1010, the system control unit 200 determines whether the power is turned off by the operation of the power button 52 or the like. In a case where the system control unit 200 determines that the power is turned off, it ends this flow, and in a case where it determines otherwise, it executes the processing of step S1001.

The operation in the restriction mode does not necessarily have to be executed in the processing illustrated in FIG. 6. For example, the guidance display in step S1006 may be omitted, and the reception of the playback menu 401 and the image deletion menu 402 may simply be disabled. In step S1006, the system control unit 200 may display the recorded video that has received demosaicing processing on the display unit 41. The transition to the playback tab screen by the menu button 53 (step S1003) itself may be disabled. The LED control of the identification unit 70 may be turned off in step S1002 and turned on in step S1007.

The operation on the restriction mode in FIG. 6 is effective regardless of the operation mode (imaging mode, distance measurement mode, and simultaneous recording mode).

Thus, in a case where the restriction mode is effective, the functions in the playback tab are restricted so that the data recorded in the recording medium 61 is not displayed on the display unit 41. The user is definitely prevented from viewing the recorded video by disabling both the playback menu 401 and the image deletion menu 402 in which thumbnail images can be confirmed. Thereby, the distance measuring apparatus 100 can be used in a state in which the recorded video cannot be viewed during a golf game in which viewing of the recorded video is prohibited. The light emission state of the LED of the identification unit 70 is switched according to whether the restriction mode is turned on or off. Thereby, a third party watching the use of the distance measuring apparatus 100 from the outside can identify whether the distance measuring apparatus 100 is being used in the restriction mode by confirming the lighting state of the identification unit 70. This configuration can prevent the user from accidentally viewing the recorded video and thus violating the rules, and secure a fair play of golf while using the distance measuring apparatus 100 without a third party suspecting that the user is violating the rules.

The distance measuring apparatus 100 may have a function of playing only the audio data recorded on the recording medium 61. Audio data includes audio files and the audio portion of moving image data. In this case, in step S1006, in addition to restricting the transition to the playback screen 410 and the image deletion screen 420, playback of the audio data recorded on the recording medium 61 is also disabled.

The golf rules also prohibit listening to audio during a golf game, but the restriction allows the user to use the distance measuring apparatus 100 without listening to the recorded audio, thereby preventing a violation of the rules.

A laser output of the distance measuring apparatus 100 may be Class 1, the lowest class of the classes defined in JIS C 6802. However, even with the Class 1 laser output, it is not recommended to irradiate the eyes, etc., due to the influence on the body.

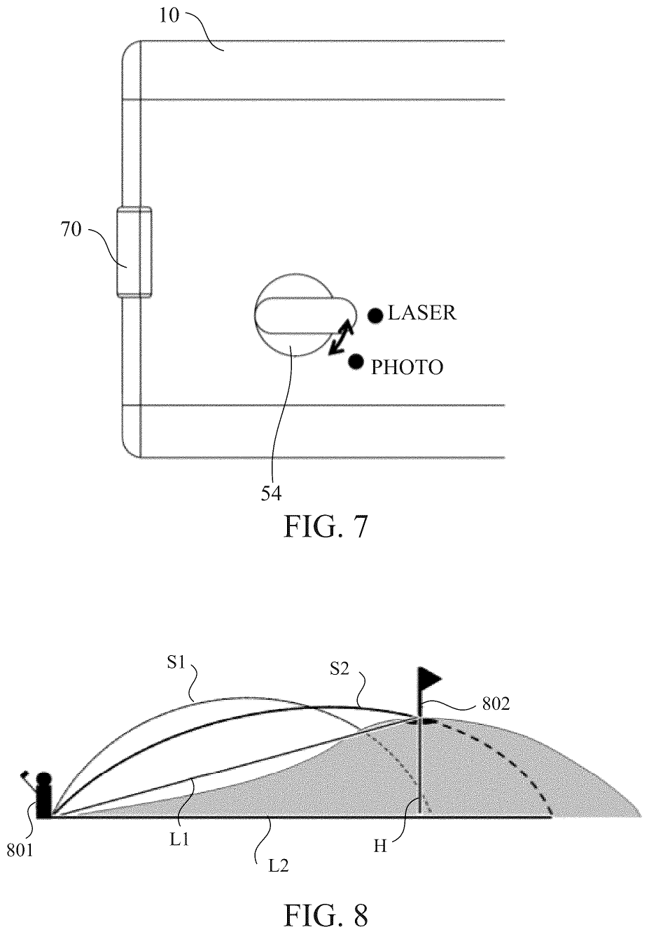

FIG. 7 is a side view of the distance measuring apparatus 100, and illustrates a structure in which the mode switching unit 54 can be set to two positions, one for emitting a laser beam (distance measurement mode and simultaneous recording mode) and the other for stopping emitting a light beam (imaging mode). Switching between the distance measurement mode and the simultaneous recording mode is performed by operating the menu button 53 and the arrow keys. By checking the set position of the mode switching unit 54, this configuration can determine whether the distance measuring apparatus 100 is in a state in which it can emit a light beam. Therefore, in a case where the distance measuring apparatus 100 is used in the imaging mode, people around it can recognize that it is in a safe state in which a light beam is not being emitted, and imaging can be safely performed. In this embodiment, the state of the distance measuring apparatus 100 can be identified by the set position of the mode switching unit 54, but this embodiment is not limited to this example as long as it can be identified from the external state of the mode switching unit 54.

On the other hand, even if the distance measuring apparatus 100 is set to the imaging mode in the above configuration, if the restriction mode is turned off, recorded videos that violate the rules of golf can be viewed. In other words, even if the distance measuring function is turned off and distance measurement for the purpose of the competition is not performed, this does not prove that the rules are not violated. Turning on the restriction mode and clearly indicating that the restriction mode is set by the identification unit 70 prove that the rules are being observed. As in the above configuration, independently placing the mode switching unit 54 and the identification unit 70 on the outer surface of the distance measuring apparatus 100 can inform people around the user that the imaging is being performed safely and in compliance with the rules of golf.

The distance measuring apparatus 100 may have an elevation difference correction function. FIG. 8 is a schematic diagram of the elevation difference correction function of the distance measuring apparatus 100, illustrating distance measurement and the shot trajectory of a golf ball on a golf course with elevation differences. A player 801 measures distance L1 to a flag 802 using the distance measuring apparatus 100. However, if a shot is made based on the distance L1, the ball will fly on a trajectory of trajectory S1 and will not reach the flag 802, which is higher than the player 801. Accordingly, in a case where the elevation difference correction function is used, the system control unit 200 calculates height H from the orientation of the distance measuring apparatus 100 during distance measurement obtained by the orientation detector 209 and the distance L1. Next, corrected distance L2 is calculated using the height H and the distance L1, and the corrected distance L2 is displayed on the display unit 41 as an image 306. By taking a shot based on the displayed correction distance L2, the player 801 can hit the ball on a trajectory S2 that reaches the flag 802.

In FIG. 8, the target flag 802 is higher than the player 801, but even if the flag 802 is lower than the player 801, the necessary correction distance L2 can be calculated by a similar calculation.

On the other hand, the golf rules do not permit measuring elevation differences. Therefore, in a round to which the golf rules apply, using an elevation difference correction function that can obtain elevation differences is a violation of the rules.

Accordingly, in a case where the restriction mode is enabled, the elevation difference correction function is also disabled. In a case where a distance measurement operation is performed while the restriction mode is enabled, the distance L1 is displayed as the image 306. Thereby, the user can prevent violations of the rules regarding the measurement of elevation differences as well as the rules regarding the playback of recorded videos. In addition, a third party watching the use of the distance measuring apparatus 100 from the outside can also identify whether the user is following the rules by confirming the LED light emission state of the identification unit 70.

In a case where the restriction mode is turned off, the elevation difference correction function may be switched between the turning-on and the turning-off separately from switching between turning on and off of the restriction mode.

### Second Embodiment

This embodiment will describe only the configuration different from that of the first embodiment, and omit the common configuration.

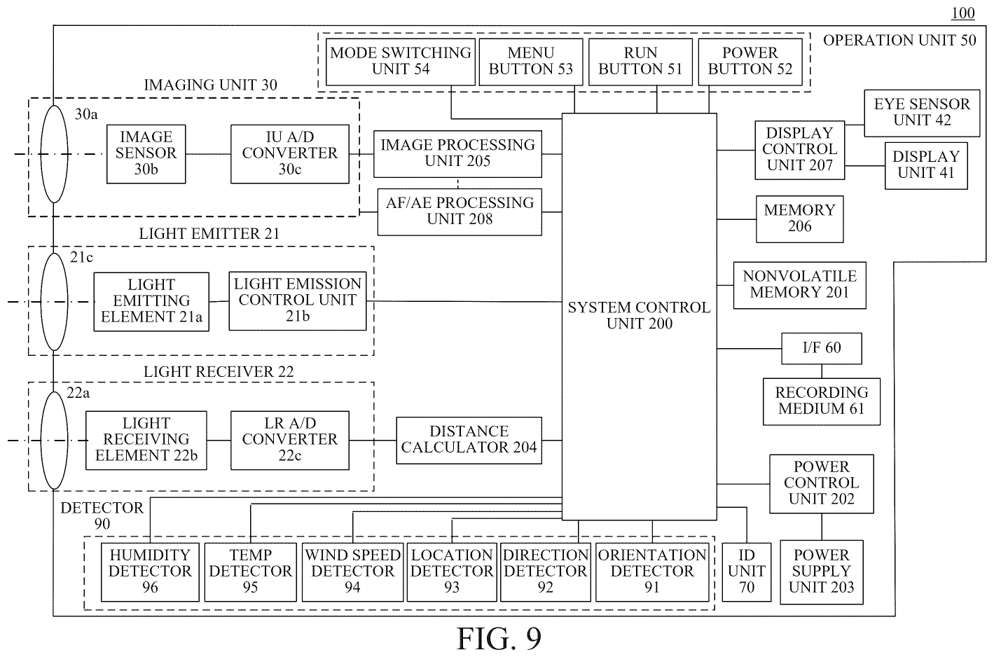

FIG. 9 is a block diagram of the distance measuring apparatus 100 according to this embodiment.

The identification unit 70 is an exterior portion that can identify the turning-on and turning-off states of the restriction mode, and for example, switches the display state by turning on and off an LED disposed inside. The LED may be a full-color LED capable of emitting RGB light, or multiple LEDs may be disposed.

A detector 90 includes a group of devices that detect various information inside and outside the distance measuring apparatus 100, and each detection device has a name according to its function. FIG. 9 illustrates an orientation detector 91, a direction (azimuth) detector 92, a location detector 93, a wind speed detector 94, a temperature detector 95, and a humidity detector 96, but these are examples, and the type and number of detection devices are not limited.

The orientation detector 91 uses, for example, a gyro sensor, and detects the orientation of the distance measuring apparatus 100. The orientation information obtained by the orientation detector 91 may be sent to the system control unit 200 and used to correct the elevation difference. The orientation information obtained by the orientation detector 91 may also be used as image stabilizing information for image stabilization in the imaging unit 30.

The direction detector 92 includes, for example, a geomagnetic sensor, and detects the direction in which the distance measuring apparatus 100 is facing. Using the orientation information obtained by the direction detector 92, the system control unit 200 may execute a direction display function and superimpose the information on the live-view image or recorded image on the display unit 41. By knowing the direction, the user can refer to which direction on the golf course to hit the ball.

The location detector 93 includes, for example, a GPS sensor, and detects the current location of the distance measuring apparatus 100. Using the position information obtained by the location detector 93, the system control unit 200 may execute a location display function and superimpose the information onto the live-view image or recorded image on the display unit 41. By knowing the current location, the user can grasp the current position on the golf course.

The wind speed detector 94 includes, for example, a wind speed sensor, and detects a wind speed hitting the distance measuring apparatus 100. The wind direction may also be detected in conjunction with the information from the direction detector 92. Using the wind speed information obtained by the wind speed detector 94, the system control unit 200 may execute a wind speed and wind direction display function and superimpose it on the live-view image or recorded image of the display unit 41. By knowing the wind speed and wind direction, the user can predict the effect of the wind in hitting a golf ball.

The temperature detector 95 includes, for example, a temperature sensor, and detects the temperature outside the distance measuring apparatus 100. Using the temperature information obtained by the temperature detector 95, the system control unit 200 may execute a temperature display function and superimpose it on the live-view image or recorded image of the display unit 41. By knowing the temperature, the user can predict the hardness of the golf ball at the time of the shot.

The humidity detector 96 includes, for example, a temperature sensor, and detects the humidity outside the distance measuring apparatus 100. Using the humidity information obtained by the humidity detector 96, the system control unit 200 may execute a humidity display function and superimpose it on the live-view image or recorded image of the display unit 41. By knowing the humidity, the user can predict the air resistance and the like that will be applied to the hit golf ball.

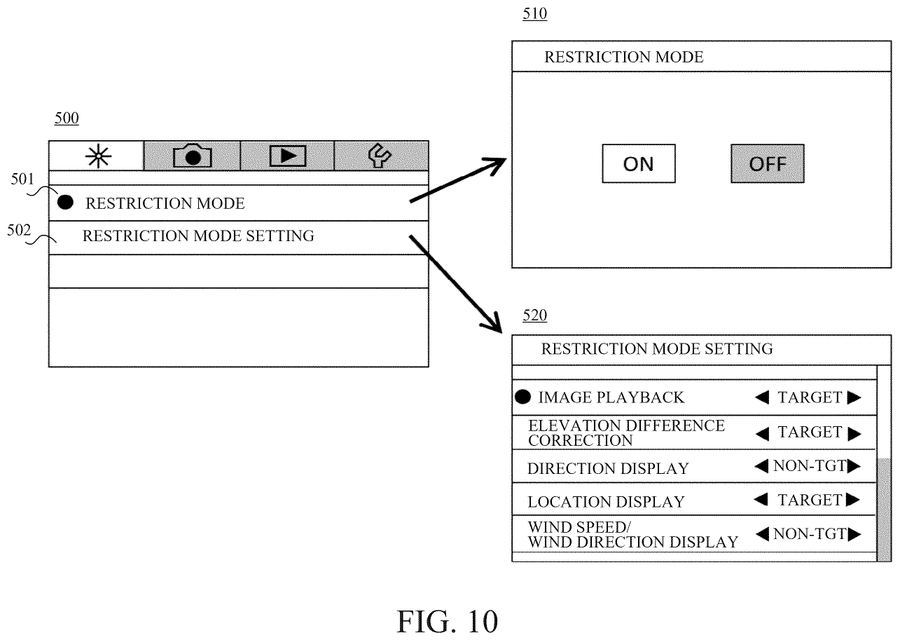

FIG. 10 is a transition diagram of the GUI displayed on the display unit 41 in performing a setting regarding the restriction mode of the distance measuring apparatus 100. In this embodiment, the restriction mode is a mode in which a selected function among a plurality of functions is disabled. Operating the menu button 53 and the arrow keys transitions to the setting tab screen 500. In a case where the restriction mode setting menu 502 is executed on the setting tab screen 500, a restriction mode setting screen 520 is displayed in which it is possible to set which functions are to be disabled in a case where the restriction mode is active. For example, operating left and right arrow keys can set each function as being restricted or not restricted. The set contents are saved as a setting file in the nonvolatile memory 201 via the system control unit 200.

FIG. 10 illustrate image playback, elevation difference correction, direction display, location display, and wind speed/wind direction display as functions that can be set as being disabled. These are illustrative, and other functions such as temperature display, humidity display, air pressure display, and image recording may also be included, and the functions that are the target of the restriction mode are not limited to them.

The setting of the target/non-target of the restriction mode may be changed on a screen other than the restriction mode setting screen 520. For example, the playback menu 401 or the image deletion menu 402 may be selected on the playback tab screen 400 to set the functions regarding playback to the target to be restricted in the restriction mode.

The colors of the LEDs emitted by the identification unit 70 correspond one-to-one with the respective functions.

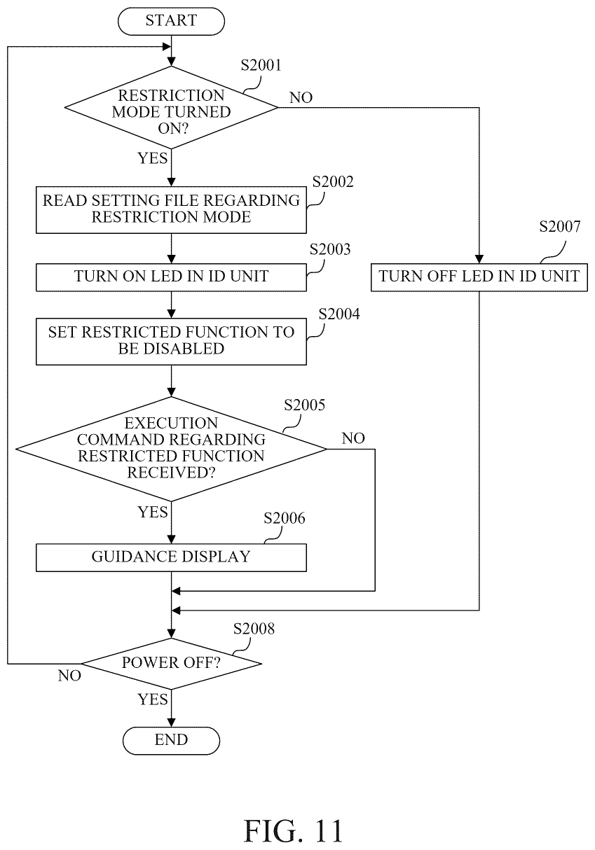

FIG. 11 is a flowchart illustrating the operation of the distance measuring apparatus 100 in the restriction mode according to this embodiment. The processing of the flowchart is achieved by the system control unit 200 executing a program stored in the nonvolatile memory 201 and controlling the operation of each unit. The processing of the flowchart of FIG. 11 is executed from when the power supply of the distance measuring apparatus 100 is turned on.

In step S2001, the system control unit 200 determines whether or not the distance measuring apparatus 100 is set to the restriction mode. In a case where the system control unit 200 determines that the distance measuring apparatus 100 is set to the restriction mode, the system control unit 200 executes the processing of step S2002, and in a case where the system control unit 200 determines that the distance measuring apparatus 100 is not set to the restriction mode, the system control unit 200 executes the processing of step S2007.

In step S2002, the system control unit 200 refers to the nonvolatile memory 201 and reads a setting file (setting file regarding the restriction mode) in which a list of functions that are targets of the restriction mode is stored.

In step S2003, the system control unit 200 causes the LED of the identification unit 70 to emit light. At this time, the color of the LED may change according to the type of restricted function based on the contents of the loaded setting file. For example, the color of the LED may change as follows: a first color in a case where a first function is restricted, a second color in a case where a second function is restricted, and a third color in a case where both the first and second functions are restricted. The color of the LED may change over time, or a plurality of LEDs may emit different colors simultaneously.

In step S2004, the system control unit 200 disables (deactivates) a function that is a target to be restricted (function that is being restricted or restricted function).

In step S2005, the system control unit 200 determines whether or not it has received an execution command regarding the restricted function based on the user's operation of the operation unit 50, etc. In a case where the system control unit 200 determines that it has received an execution command, it executes the processing of step S2006, and in a case where it determines that it has not received an execution command, it executes the processing of step S2008.

In step S2006, the system control unit 200 displays guidance indicating that the restricted function cannot be executed while the restriction mode is set or the like, and does not execute the function for which an execution command has been received.

In step S2007, the system control unit 200 turns off the LED of the identification unit 70.

In step S2008, the system control unit 200 determines whether the power is turned off by the operation of the power button 52, etc. In a case where the system control unit 200 determines that the power is turned off, it ends this flow, and in a case where it determines otherwise, it executes the processing of step S2001.

The operation in the restriction mode does not necessarily have to be performed as illustrated in FIG. 11. For example, the turning on of the LED in step S2003 and the function restriction in step S2004 may be executed in the reverse order.

The operation regarding the restriction mode in FIG. 11 is effective regardless of the operation mode (imaging mode, distance measurement mode, and simultaneous recording mode).

Thus, by allowing the user to freely set the functions to be restricted in the restriction mode, even if prohibited matters are changed due to a revision of the golf rules or functions outside the rules are prohibited by local rules, the distance measuring apparatus 100 can be used in the corresponding restriction mode. The light emission state of the LED of the identification unit 70 switches according to whether the restriction mode is turned on or off, and the emitted light color becomes a color corresponding to the restricted function. A third party who is watching the use of the distance measuring apparatus 100 from the outside can also distinguish whether the distance measuring apparatus 100 is being used in a proper restriction mode by looking at the light emission state of the LED of the identification unit 70. The above configuration can prevent the user from accidentally violating the rules, and secure a fair play of golf fairly with the distance measuring apparatus 100 without a third party suspecting that the user is violating the rules.

In a case where the distance measuring apparatus 100 is being used in a restriction mode that complies with the golf rules established by the golf association, the identification unit 70 may be determined to emit light in a specific color. This configuration can determine whether or not the distance measuring apparatus 100 is being used in a restriction mode that complies with the golf rules, without having to check the light emission color for each function.

In a case where the golf rules are revised and the restrictions are changed, a firmware update for the distance measuring apparatus 100 may be distributed in accordance with the revised rules, and the specific emitted light color may be updated to a color different from that before the update. This configuration enables people around the distance measuring apparatus 100 to determine whether or not the distance measuring apparatus 100 is being used in a restriction mode that complies with the latest rules of golf.

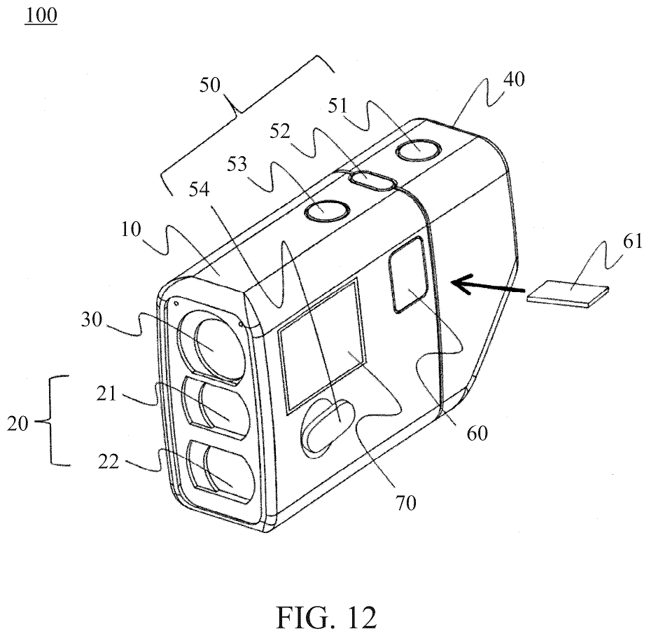

FIG. 12 also illustrates the distance measuring apparatus 100 having a liquid crystal panel (display screen) as the identification unit 70. A list of functions that can be set as targets of the restriction mode can be displayed on the panel. For example, icons indicating each function may be displayed, or the names of the functions may be displayed.

At this time, in step S2003, the system control unit 200 displays only the functions that are targets to be restricted on the liquid crystal panel of the identification unit 70. Alternatively, only the functions that are not targets to be restricted may be displayed on the liquid crystal panel. A list of all functions that can be set as targets of the restriction mode may be displayed, and the restricted functions and the unrestricted functions may be displayed with different luminances. At this time, only the restricted functions may be displayed more brightly, or only the unrestricted functions may be displayed more brightly. These are merely illustrative, and the display method for distinguishing between restricted and unrestricted functions is not limited. Due to this configuration, the user and a third party who is watching the use of the distance measuring apparatus 100 from the outside can easily identify which functions of the distance measuring apparatus 100 are restricted.

### Other Embodiments

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has described example embodiments, it is to be understood that some embodiments are not limited to the disclosed embodiments. The scope of the following claims is to be accorded the broadest interpretation so as to encompass all such modifications and equivalent structures and functions.

For example, this embodiment provides the distance measuring apparatus with means (a unit) for enabling a user to manually set the restriction mode, but in another embodiment, the distance measuring apparatus includes a communication unit communicable with a clubhouse of a golf course, a tournament organizer, or the golf association or its subsidiary, or the like (referred to as a host hereinafter) and means (a unit) for automatically setting the restriction mode through the communication or under control of the host. The communication may include information regarding an address (such as a GPS information) of the golf course, the date and time of the tournament, and the like. For example, the restriction mode may not be automatically set before the tournament starts or after the tournament ends, or in the case of golf lessons. Moreover, this embodiment provides a distance measuring apparatus with means (a unit) for making the restriction mode identifiable (recognizable) from the outside (third party), but as long as the host can recognize that the restriction mode is properly working in the distance measuring apparatus through the communication, the means for making the restriction mode identifiable (recognizable) from the outside may be omitted.

Each embodiment can provide a distance measuring apparatus that can comply with the rules of golf and secure fair play.

This application claims priority to Japanese Patent Application No. 2023-214353, which was filed on Dec. 20, 2023, and which is hereby incorporated by reference herein in its entirety.

What is claimed is:

1. A distance measuring apparatus comprising:
an imaging unit configured to image an object;
a distance measuring unit configured to measure a distance to the object using a time from when light is irradiated onto the object to when reflected light from the object is received;
a display unit configured to display an image obtained by the imaging unit;
a recorder configured to record the image;
a processor configured to execute control to prohibit the image recorded in the recorder from being displayed on the display unit; and
an notification unit configured to notify outside that the control is being executed.

2. The distance measuring apparatus according to claim 1, wherein the processor is configured to:
delete from the recorder the image corresponding to a thumbnail image selected from a plurality of thumbnail images displayed on the display unit, and
prohibit the plurality of thumbnail images from being displayed on the display unit while the control is being executed.

3. The distance measuring apparatus according to claim 1, wherein the processor is configured to restrict playback of audio data recorded in the recorder while the control is being executed.

4. The distance measuring apparatus according to claim 1, further comprising a mode switching unit configured to switching between a first mode for irradiating the light and a second mode for stopping irradiating the light,
wherein which of the first mode and the second mode is set is identifiable from an external appearance of the mode switching unit.

5. The distance measuring apparatus according to claim 4, wherein the mode switching unit is disposed separately from the notification unit.

6. The distance measuring apparatus according to claim 4, wherein the processor is configured to prohibit the image from being displayed on the display unit while one of the first mode and the second mode is set and the control is being executed.

7. The distance measuring apparatus according to claim 1, wherein the processor is configured to:
acquire information regarding an elevation difference between the distance measuring apparatus and the object, and
not acquire the information while the control is being executed.

8. The distance measuring apparatus according to claim 1, wherein the processor is configured to set at least one function selected from a plurality of functions to be disabled, and
wherein the notification unit notifies the outside that the processor has set the at least one function to be disabled.

9. The distance measuring apparatus according to claim 8, wherein the at least one function is at least one of playback of the image, display of an elevation difference, display of a direction, display of a location, display of a wind speed, display of an temperature, display of a humidity, display of an air pressure, and recording of the image.

10. The distance measuring apparatus according to claim 8, wherein the notification unit emits light in at least two or more colors.

11. The distance measuring apparatus according to claim 10, wherein the notification unit changes an emitted light color according to the at least one function that is set to be disabled.

12. The distance measuring apparatus according to claim 8, wherein the notification unit includes a display screen for displaying information regarding the at least one function in a case where the processor has set the at least one function to be disabled.

13. The distance measuring apparatus according to claim 8, wherein the notification unit includes a display screen for displaying information regarding functions that are not disabled in a case where the processor has set the at least one function to be disabled.

14. The distance measuring apparatus according to claim 8, wherein the notification unit displays, at different luminances, information regarding the at least one function and information regarding functions that are not disabled in a case where the processor has set the at least one function to be disabled.

15. A control method of a distance measuring apparatus that includes an imaging unit configured to image an object, a distance measuring unit configured to measure a distance to the object using a time from when light is irradiated onto the object to when reflected light from the object is received, a display unit configured to display an image obtained by the imaging unit, and a recorder configured to record the image, the control method comprising the steps of:
executing control to prohibit the image recorded in the recorder from being displayed on the display unit; and
notifying outside that the control is being executed.

16. A non-transitory computer-readable storage medium storing a program that causes a computer to execute the control method according to claim 15.
